(19) United States
(12) Patent Application Publication
(10) Pub. No.: US 2003/0188197 A1
(43) Pub. Date: Oct. 2, 2003

(54) Improper access prevention program, method, and apparatus

(75) Inventors: Kaori Miyata, Kawasaki (JP); Ichiro Miyajima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/316,100

(22) Filed: Dec. 11, 2002

(30) Foreign Application Priority Data
Mar. 28, 2002 (JP) 2002-092035

(51) Int. Cl. G06F 11/30; G06F 15/173

(52) U.S. Cl. 713/201; 709/224

(57) ABSTRACT

An improper access prevention program is provided that executes processing for preventing improper access through a network, whereby the task load on the administrator can be alleviated and a plurality of sites protected by a plurality of protection means can be effectively and efficiently protected, and such improper access prevention program is designed to cause administration means connected to a plurality of protection means and a plurality of detection means through a network to receive improper access information detected by any of the detection means, to decide, in accordance with this received information, on protection means where counter-measures against this improper access are to be implemented and decide on the particulars of the protective counter-measures in respect of the protection means, and to give instructions for the implementation of said protective counter-measures that have been decided upon to the protection means.

### BACKGROUND OF THE INVENTION

1. Field of the Invention

The present invention relates to a program for executing processing, a method, and a apparatus for preventing improper access through a network and in particular relates to a program, a method, and a apparatus for preventing improper access whereby the burden on the administrator can be alleviated and a plurality of sites connected to the network can be effectively protected from improper access.

2. Description of the Related Art

With the spread of the Internet and intranets in recent years, the number of systems connected to networks has rapidly increased and, accompanying this, the number of incidents of damage suffered due to improper access through the network has also increased. Conventionally, in ordinary sites, the counter-measures adopted in order to prevent such improper access through networks are provision of firewalls or IDS (Intrusion Detection Systems) etc.

A firewall is a mechanism provided between an external network such as the Internet and one's own site in order to protect one's own site from improper access. In general, with a firewall, improper entry is prevented by filtering, whereby conditions such as the IP addresses of the communicating parties and the protocols employed etc are registered and accesses matching such conditions are allowed or accesses matching such conditions are denied. With this method, it is necessary to know the communicating parties beforehand in order to register the aforementioned conditions; however, if the communicating parties are not known beforehand, the method of allowing communication dynamically by for example performing user authentication every time access is made can be adopted.

Also, IDS is a system for detecting improper intrusion; the network is constantly monitored and if improper access is attempted this is detected. Specifically, patterns of communication data and/or sequences of improper access are registered beforehand and communication data or sequences flowing on the network being monitored are regarded as improper access if they match a previously registered pattern. If improper access is detected, communication is effected by for example e-mail with the administrator.

Also, counter-measures involving a combination of the aforementioned firewalls and IDS may be employed. In this case, if improper access is detected by IDS, this information is communicated to the firewall and, using this information, the firewall is set to discard packets coming from the IP address that is the source of this improper access. In this way, improper intrusion can be prevented since packets sent from the source of this improper access are discarded by the firewall.

However, the conventional methods of preventing improper access described above were subject to the following problems. First of all, with the method of setting up a firewall only, as described above, the conditions for allowing passage or blocking must be registered beforehand; since it is difficult to alter these conditions dynamically, in order to achieve effective protection, the administrator needs to alter these conditions as occasion demands. Also, in the case of setting up only IDS or where IDS is not linked with a firewall, as described above, although the IDS performs detection of improper access and gives notification of this, counter-measures against the improper access such as altering the firewall conditions must be performed by a manual operation by the administrator after receiving the notification. In either case, the burden on the administrator was considerable.

Also, although, as described above, if the firewall and IDS were linked in combination, counter-measures in the firewall could automatically be taken on detecting improper access by the IDS, in some cases, the IDS mistakenly identified as improper access access which was not with malicious motive. For example, if by mistake a large file was attached to an e-mail, even though the sender had no malicious motive, this might be identified by the IDS as improper access, causing the firewall to be automatically set to deny access from the sender in question; thus access became impossible from this sender who in fact needed to communicate. Consequently, with this method, communication which was in fact necessary could become impossible due to counter-measures being implemented as a result of spurious detection, presenting an obstacle to the conduct of business tasks etc.

Furthermore, conventionally, when protective devices such as firewalls were set up, including when these were linked with IDS as described above, detection of improper access, determination of counter-measures and implementation of counter-measures etc were performed for each protective device individually; even when a plurality of protective devices such as firewalls were connected to the network, these were mutually independent. However, recent attacks using improper access are increasingly large-scale attacks, in which the same kind of improper access is performed in respect of a large number of sites. Consequently, in such cases, there is a high probability that if improper access is being made to a single site it is also being made to other sites.

However, in the above conventional situation, since counter-measures were only effected in respect of the protective devices of the site where improper access was actually made and counter-measures were not effected at other protective devices, the same detection, determination of counter-measures and implementation of counter-measures had to be performed when this improper access was respectively effected at the other protective devices also. Thus, in cases where improper access could only be detected after damage had already occurred, since, as explained above, the fact that one site had experienced improper access was not reflected at other protective devices, many sites undergoing improper access could sustain damage at once. The above conventional methods did not therefore result in effective and efficient protection in respect of wide-ranging attacks.

### SUMMARY OF THE INVENTION

Accordingly, an object of the present invention is to provide an improper access prevention program that executes processing for preventing improper access through a network whereby the task load on the administrator can be alleviated and a plurality of sites protected by a plurality of protection means can be effectively and efficiently protected.

In order to achieve this object, according to a first aspect of the present invention, administration means connected to a plurality of protection means and a plurality of detection means through a network, on receiving improper access information detected by any of the detection means, using this information, decides on protection means where counter-measures against this improper access are to be implemented and decides on the particulars of the protective counter-measures in respect of the protection means and gives instructions for the implementation of said decided protective counter-measures to the protection means. Consequently, since, according to the present invention, the administration means makes the protection means such as firewalls automatically implement counter-measures, the task load on the administrator can be alleviated. Furthermore, since counter-measures in accordance with the respective situation are taken in integrated fashion in respect of a plurality of protection means in response to improper access detected by any of the detection means, a plurality of sites can be effectively and efficiently protected.

In order to achieve the above object, according to a further aspect of the present invention, an improper access prevention program causes administration means connected through a network with a plurality of protection means that execute counter-measures for protecting prescribed sites from improper access through said network and a plurality of detection means that detect said improper access, to execute processing for preventing said improper access, said preventing processing comprises: a first step of receiving information relating to improper access detected by any of said detection means from the detection means that detected this improper access; a second step of, in accordance with said received information relating to improper access, deciding on said protection means where counter-measures in respect of this improper access are to be implemented and deciding said counter-measures in respect of each said decided protection means; and

a third step of sending instruction information for implementation of said decided counter-measures to each said decided protection means.

Furthermore, according to a preferred embodiment of the present invention, the information relating to said improper access includes the type of said improper access and the decision regarding the protection means where said counter-measures are to be implemented in said second step is performed in accordance with the type of said improper access. Consequently, effective improper access prevention counter-measures can be implemented such as implementing counter-measures at all of the protection means if the improper access is of the type that attacks over a wide range.

Also, according to another embodiment of the present invention, said preventing processing further comprises a fourth step of sending instruction information, in regard to said protection means that sent said instruction information in said third step, to stop said counter-measures in respect of which instructions for execution were given by said instruction information. Consequently, even in cases where required communication has become impossible due to counter-measures being implemented as a result of spurious detection of improper access, these counter-measures are thereafter removed, so the required communication is ensured; the adverse results produced by spurious detection can thereby be reduced compared with conventionally.

Also, according to another preferred embodiment of the present invention, in addition, said preventing processing comprises a step of receiving information relating to the condition of implementation of said counter-measures at said protection means from said protection means and displaying the received information relating to the condition of implementation.

In order to achieve the above object, according to a further aspect of the present invention, an improper access prevention program causes protection means that protects prescribed sites from improper access through a network, to execute processing for implementing counter-measures in respect of said improper access in accordance with instructions from administration means that administers said protection means, said implementing processing comprises a receiving step of receiving from said administration means instruction information designating the counter-measures to be implemented in respect of said improper access decided on by said administration means, through said network; a decision step of deciding beforehand whether or not counter-measures in respect of the improper access decided by said administration means in accordance with said instruction information are to be implemented, in accordance with rules stored in said protection means; and an implementation step wherein, if, in said decision step, it is decided that counter-measures in respect of said improper access are to be implemented, these counter-measures are implemented and if it is decided that counter-measures in respect of said improper access are not to be implemented these counter-measures are not implemented. Appropriate counter-measures can therefore be implemented in a flexible manner reflecting the situation at each protection means.

Further objects and characteristics of the present invention will be apparent from the embodiments of the invention described below.

### BRIEF DESCRIPTION OF THE DRAWINGS

FIG. 1 is a network layout diagram relating to an embodiment of an improper access prevention system that executes processing using an improper access prevention program embodying the present invention;

FIG. 2 is a view illustrating the construction within manager 1 according to this embodiment;

FIG. 3 is a view illustrating the construction within firewall 2 according to this embodiment;

FIG. 4 is a view illustrating an example of the construction when no action agent is provided within firewall 2;

FIG. 5 is a view illustrating the construction within monitor 3 according to this embodiment;

FIG. 6 is a flow chart illustrating an example of the processing performed by an improper access prevention system according to this embodiment;

FIG. 7 is a view illustrating an example of improper access rules for the decision stored in improper access rules section 33;

FIG. 8 is a view illustrating an example of improper access information sent by monitor 3;

FIG. 9 is a view illustrating an example of counter-measures rules stored in counter-measures rules section 15;

FIG. 10 is a view illustrating an example of instruction information created by action section 16;

FIG. 11 is a view illustrating an example of setting of IP filter 22;

FIG. 12 is a view illustrating the construction of manager 1 and firewall 2 according to a first modified example;

FIG. 13 is a flow chart illustrating an example of processing relating to display of the condition of IP filter 22 in this modified example;

FIG. 14 is a view illustrating an example of the information regarding the set condition of IP filter 22 displayed by condition display section 17;

FIG. 15 is a view illustrating the construction of manager 1 according to a second modified example;

FIG. 16 is a flow chart illustrating an example of processing performed in an improper access prevention system according to a second modified example;

FIG. 17 is a view illustrating an example of counter-measures rules in the second modified example;

FIG. 18 is a view illustrating the construction of firewall 2 according to a third modified example;

FIG. 19 is a flow chart illustrating an example of the processing performed in the improper access prevention system according to the third modified example; and

FIG. 20 is a view illustrating an example of local rules stored in local rules section 26 of firewall 2.

### DESCRIPTION OF THE PREFERRED EMBODIMENTS

Embodiments of the present invention are described below with reference to the drawings. However, the technical scope of the present invention is not restricted by these embodiments. Identical or similar items in the drawings are described with the same reference numeral or reference symbol affixed.

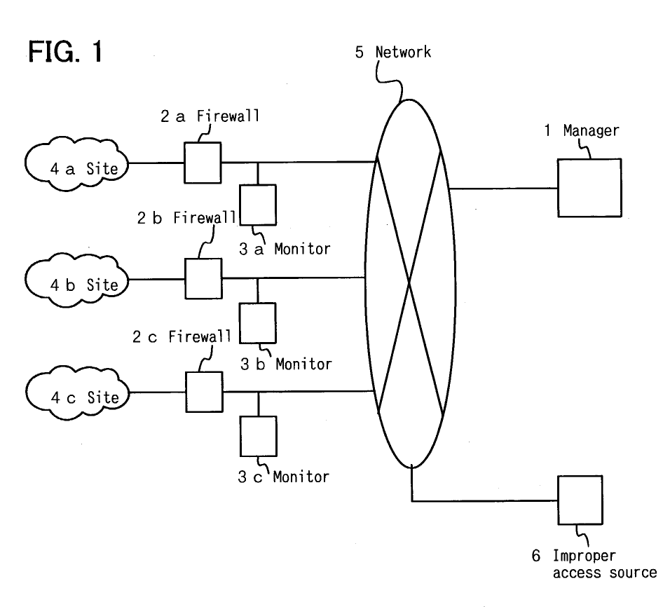

FIG. 1 is a network layout diagram according to an embodiment of an improper access prevention system that executes processing in accordance with an improper access prevention program embodying the present invention. As shown in this Figure, the improper access prevention system comprises a manager 1, a plurality of firewalls 2 (2a, 2b, 2c, . . . ) and a plurality of monitors 3 (3a, 3b, 3c, . . . ) mutually connected by means of a network 5 such as the Internet.

Firewalls 2 are devices (protection means) for protecting sites 4 (4a, 4b, 4c . . . ) respectively connected thereto and block improper access from an improper access source 6 through a network 5 using set conditions. An intranet or the like may be present at site 4. Although only a single improper access source 6 is shown in FIG. 1, there could be more than one.

Monitor 3 is a detection device (detection means) for improper access provided for each firewall 2; it constantly monitors network 5 and if it detects improper access communicates this information to manager 1.

Manager 1 is an administration device (administration means) that administers the plurality of firewalls 2 and decides upon counter-measures in respect of the improper access detected, using the information from one or other of the plurality of monitors 3; it gives instructions to the firewalls 2 to carry out the counter-measures decided upon. Manager 1 may be constituted by a computer system such as a server connected with network 5 and a program that causes this computer system to execute the aforementioned processing.

Manager 1 of the improper access prevention system according to this embodiment constructed as described above aims to effectively and efficiently protect a plurality of sites 4 connected to a plurality of firewalls 2 by determining firewalls 2 that are to execute counter-measures and the particulars of the counter-measures in respect of these firewalls 2 using the information regarding improper access detected at any location within its administrative range and causing firewalls 2 to execute these counter-measures.

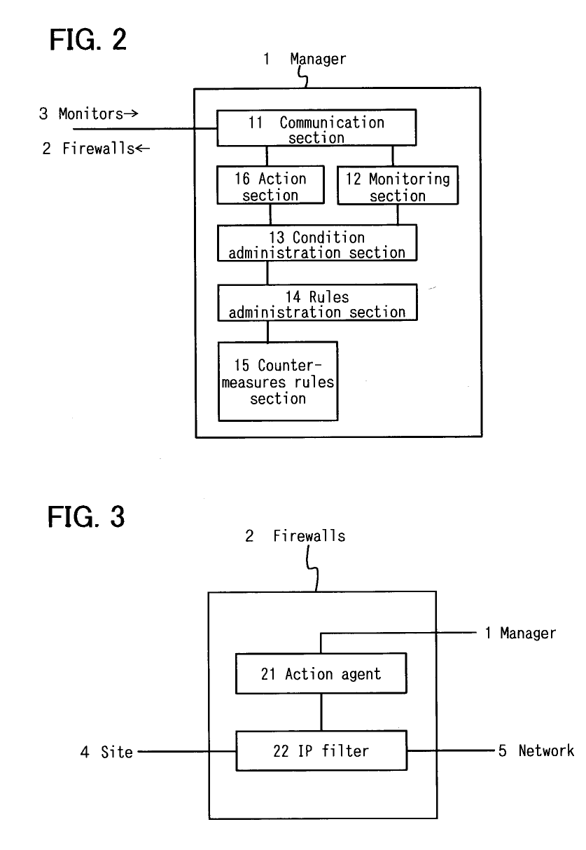

FIG. 2 is a view illustrating the construction 1 within manager 1 according to this embodiment. Communication section 11 shown in this Figure is a portion that performs communication with the firewalls 2 and monitor 3 through network 5; monitoring section 12 is a portion that receives information regarding improper access mentioned above from monitor 3. Also, condition administration section 13 is a portion that performs administration of improper access events and records and administers the improper access condition communicated thereto from monitor 3.

Next, rule administration section 14 is a portion that determines counter-measures in respect of improper access of which it has been notified and administers the necessary counter-measures rules for determining this. Also, counter-measures rules section 15 is a portion that stores counter-measures rules for determining counter-measures in respect of this improper access. The stored counter-measures rules determine the firewalls 2 at which counter-measures are to be implemented and the particulars of these counter-measures for each type of improper access detected; a detailed description of these rules will be given later. Also, action section 16 is a portion that creates the information for instructing the firewalls 2 regarding the counter-measures determined by rule administration section 14 and transfers the instruction information which it thus creates to communication section 11.

The various sections constituting manager 1 may be constructed of a program for executing processing, a control device that executes processing in accordance with this program and a data recording device etc.

FIG. 3 is a view illustrating the construction within firewalls 2 according to this embodiment. As shown in this Figure, a firewall 2 comprises an action agent 21 and an IP filter 22. IP filter 22 is an IP packet filtering module that allows passage of packets or denies passage of packets sent to firewall 2 in accordance with conditions such as the set IP address. These conditions for determining passage/denial are constituted by the IP address and protocol etc of the source and destination; their particulars will be described later.

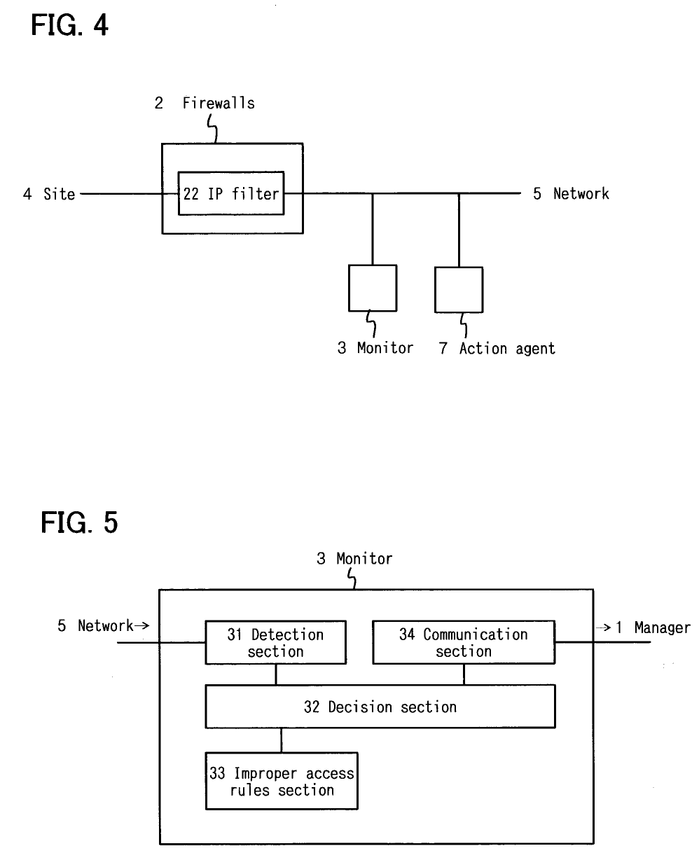

Also, action agent 21 is a portion that receives the instruction information regarding counter-measures described above sent from manager 1 and sets the conditions of IP filter 22 in accordance with these instructions. Action agent 21 and IP filter 22 may also be constituted by a program for executing processing, a control device for executing processing in accordance with this program and a data recording device etc. Also, as shown by way of example in FIG. 4, an arrangement could be adopted in which, instead of providing action agent 21 within firewall 2, this is provided as an independent action agent 7 connected with network 5. In this case also, action agent 7 performs condition setting of IP filter 22 within firewall 2 in accordance with instructions from manager 1.

FIG. 5 is a view showing the internal construction of monitor 3 according to this embodiment. Detection section 31 shown in the Figure is a portion that constantly monitors communication flowing on network 5 to which monitor 3 is connected and detects access to sites 4 protected by firewall 2 provided together with this monitor 3. Next, decision section 32 is a portion that, when the detection section detects access, decides whether or not this access is improper access. Specifically, it compares the particulars of the improper access such as the improper access communication data or sequence pattern etc registered in improper access rules section 33 with the detected access particulars and if these match decides that improper access is occurring.

Improper access rules section 33 is a portion that stores the improper access rules for identifying improper access by decision section 32; the particulars of the improper access is registered therein for each type of improper access. The specific particulars of the improper access rules will be described later. Also, communication section 34 is a portion that, if improper access is identified by decision section 32, communicates information regarding this improper access to manager 1. The information that is communicated includes information identifying the firewall 2 at the location where improper access was detected, information regarding the type of improper access and information regarding the transmission source and transmission destination of the improper access etc.

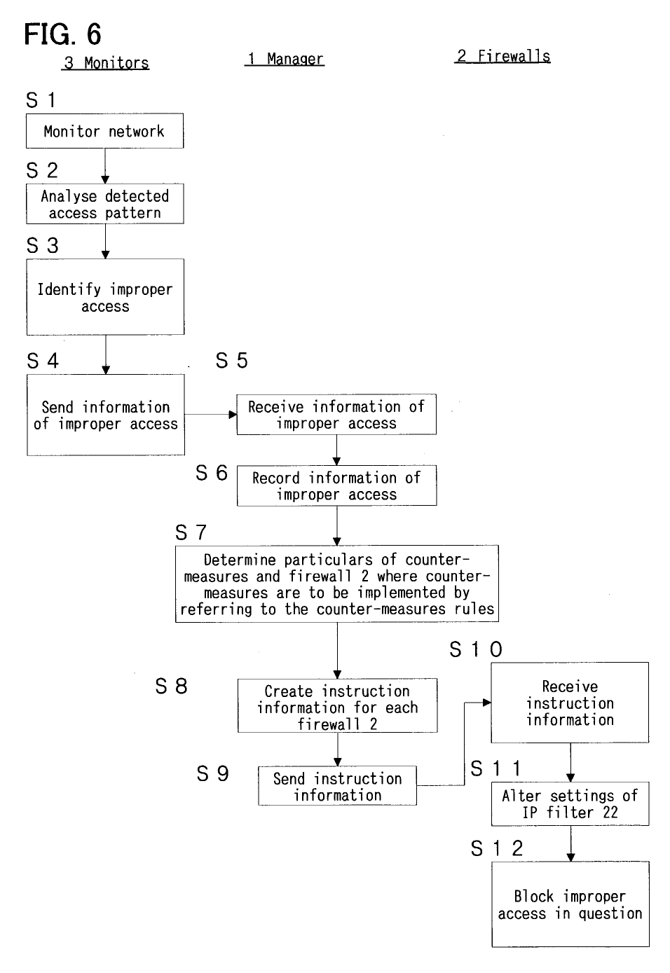

FIG. 6 is a flow chart illustrating an example of the processing performed by an improper access prevention system according to this embodiment. The particulars of the processing from the detection of improper access up to implementation of counter-measures are described below with reference to FIG. 6. First of all, the monitors 3 (3a, 3b, 3c, . . . ) that are provided at each firewall 2 respectively monitor network 5 (step S1 in FIG. 6). If then access to the site 4 (site 4a in the case of monitor 3a) protected by firewall 2 arranged with this monitor 3 is detected by any of the monitors 3, the decision section 32 of this monitor 3 analyses the communication pattern etc of the detected access (step S2 in FIG. 6). Specifically, processing such as collection and analysis of the log of firewall 2 is performed.

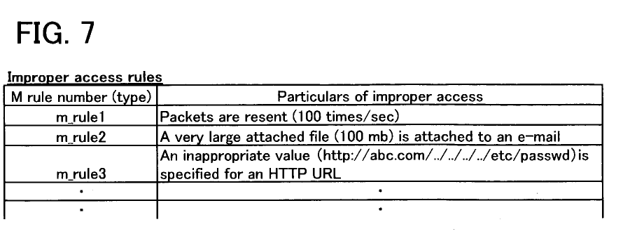

Next, decision section 32 compares the particulars of this analyzed access with the particulars of improper access registered in improper access rules section 33 and, if these match, identifies the access in question as improper access (step S3 in FIG. 6). FIG. 7 is a view showing an example of the improper access rules for making this identification stored in improper access rules section 33. As shown in the Figure, the improper access rules are constituted by an “M rule number” which is the rule number in monitor 3 and “improper access particulars”. It can therefore be arranged that a single rule is present for each set of improper access particulars and the “M rule number” indicates the type of improper access.

For example, the improper access of “m_rule1” shown in FIG. 7 consists in repeatedly resending packets without completing transmission and the improper access of “m_rule2” consists in appending files of enormous size (100 MB or more) to an e-mail that is being transmitted. And the improper access of “m_rule3” consists in accessing a URL (Universal Resource Locator) that is prohibited for access from outside. Consequently, if for example the particulars of the access detected are that this constitutes an e-mail to which a 100 MB file is appended, by “m_rule2”, this access is identified as being improper access, whereas in the case of an e-mail to which a file of 50 MB is appended this is not identified as improper access.

It should be noted that the improper access rules of monitors 3 are be registered beforehand at each monitor 3 and this registration and subsequent administration could be performed at each monitor 3 or this could be performed in integrated fashion by manager 1. Also, the particulars of the improper access rules could be different for each monitor 3 or could be the same for all of these. For convenience in the description below it will be assumed that the improper access rules of the monitors 3 are all the same.

Next, when the detected access has been identified as improper access, communication section 34 of monitor 3 sends to manager 1 information relating to this improper access (step S4 of FIG. 6). On the other hand, if the access has not been identified as improper access, transmission to manager 1 is not performed and monitoring of network 5 is continued.

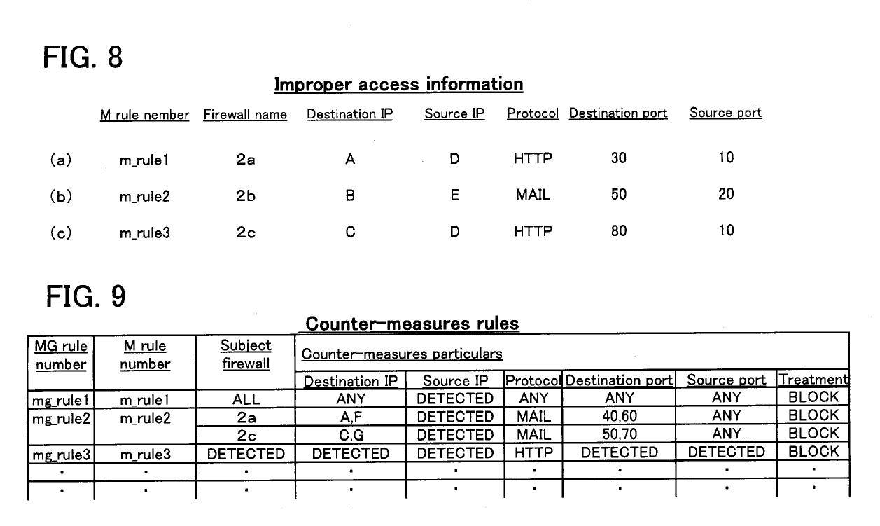

FIG. 8 is a view illustrating an example of the information of improper access transmitted by monitor 3. As shown in this Figure, the information that is transmitted includes the M rule number i.e. the type of improper access detected that is employed when identifying improper access, and the name of the firewall 2 that is provided together with this monitor 3, the IP address and port number of the destination and source of this improper access and the protocol of this improper access.

FIG. 8(a) illustrates an example of the information that is transmitted when improper access under “m_rule1” is detected by monitor 3a. From this information it can be seen that the improper access in question involves resending of packets and is access using HTTP (Hypertext Transfer Protocol) from a source of IP address D to a destination of IP address A. Likewise, FIGS. 8(b) and (c) respectively illustrate information that is sent when improper access is detected in accordance with “m_rule2” by monitor 3b and information that is sent when improper access is detected in accordance with “m_rule3” by monitor 3c.

Next, information of the aforesaid improper access that is sent from monitors 3 is received by manager 1 (step S5 in FIG. 6). Specifically, the information of the improper access is received by monitoring section 12 through communication section 11 of manager 1 and this information that is received is transferred to condition administration section 13. Condition administration section 13 records the condition of improper access that is generated in accordance with the received improper access information (step S6 in FIG. 6) and transfers the information of this improper access to rules administration section 14.

Next, using the counter-measures rules stored in counter-measures rules section 15 and the improper access information that has been received, rules administration section 14 determines the particulars of the protective counter-measures therefor and the firewalls 2 where the protective counter-measures in respect of this improper access are to be taken (step S7 in FIG. 6). Specifically, using the M rule number (type of improper access) contained in the improper access information, a single counter-measure rule is selected and the firewalls 2 indicated by this selected counter-measures rule are determined as firewalls 2 where counter-measures are to be implemented; furthermore, the particulars of the counter-measures indicated in this counter-measures rule are determined as the particulars of these protective counter-measures by being embodied in concrete form in accordance with the aforesaid improper access information.

FIG. 9 is a view showing an example of counter-measures rules stored in counter-measures rules section 15. The “Mg rule number” in the Figure is the number identifying the counter-measures rule; a single counter-measures rule is laid down for each M rule number (type of improper access) described above. The counter-measures rules that are laid down include “subject firewall” and “particulars of counter-measures”; as the “subject firewall”, when this counter-measures rule is selected, the firewall 2 at which counter-measures are to be implemented is specified. The firewall 2 at which counter-measures are to be implemented is therefore determined by the type of improper access detected by monitor 3. For example, if, as in “mg_rule1”, “ALL” is specified, all of the firewalls 2 that are being administered by this manager 1 are designated as the subject of implementation of counter-measures; also, if, as in “mg_rule2”, “2a, 2c” are specified, the specified firewalls 2a and 2c become the subjects of implementation of counter-measures; furthermore, if, as in “mg_rule3”, “detected” is specified, the firewall 2 that is arranged with monitor 3 where the improper access against which counter-measures are to be implemented was detected is specified as the subject of counter-measures implementation.

The “mg_rule1” of FIG. 9 is a counter-measures rule when the M rule number is “m_rule1” i.e. is a counter-measures rule indicating the counter-measures when improper access whose particulars are that packets are resent is detected (see FIG. 7). Then, there is a considerable likelihood that improper access of this type is being effected to a plurality of sites 4 over a wide range, so, at the time point where this is detected at a single location, as described above, “subject firewalls” is designated as “ALL” in order that counter-measures should be implemented at all firewalls 2.

Likewise, “mg_rule2” is a counter-measures rule indicating counter-measures in the case that improper access is detected whose particulars are that a very large attached file is appended to an e-mail (see FIG. 7); in the case of improper access of this type, it is possible to decide whether or not to prevent this by deeming it to be improper access, depending on the capacity of the equipment at each site 4. Thus, in the example shown in FIG. 9, only the equipment capacities of sites 4a and 4c which are protected by firewalls 2a and 2c are small, so the counter-measures are arranged to be effected only in respect of these locations.

Likewise, in the case of “mg_{—l rule}3”, the counter-measures rule indicates counter-measures when access is made to a URL whose access is prohibited from outside (see FIG. 7). Then, in the case of this type of improper access, it may be assumed that this represents improper access aiming at a specific site 4, so, in the case of the example of FIG. 9, protection is only to be applied at the site 4 in question which has been targeted and “detected” may be set for the location of implementation of counter-measures.

Next, as shown in FIG. 9, as the “counter-measures particulars” of the counter-measures rule, the IP address and protocol of the-destination and source and the port number of the destination and source are specified; it is indicated that, in the event of access matching these particulars, the counter-measure indicated in the column “treatment” i.e. “BLOCK” (blocking) in the case of the example of FIG. 9, should be performed. The “ANY” shown in FIG. 9 means that the value is not specified; for example if the “destination IP” is “ANY”, this means that the destination IP address could be any IP address.

Also, “detected” indicated in the column “source IP” of FIG. 9 means that the value is determined in accordance with the improper access information detected where counter-measures are sought to be implemented i.e. the information of the improper access transmitted from monitor 3 mentioned above. For example, “mg_rule1” of FIG. 9 is selected when the information of improper access indicated by way of example in FIG. 8(a) is transmitted. In this case, the value of “source IP” of “mg_rule1” is indicated as “detected”, so this is determined as the value “D” indicated as the “source IP” of the information of the improper access shown in FIG. 8(a). Also, “BLOCK” in the column “treatment” of FIG. 9 indicates that access is to be denied.

The counter-measures rules described above with reference to FIG. 9 are registered beforehand by the administrator etc of manager 1 and consist in particulars reflecting the needs of each site 4 designated as a subject site.

Returning to FIG. 6, in the processing of step S7 performed by the rules administration section 14 described above, if for example the improper access information shown in FIG. 8(a) is transmitted, first of all, from the counter-measures rules shown in FIG. 9, counter-measures rule “mg_rule1” is selected, in accordance with the M rule number. Thus, since “ALL” is indicated in the column “subject firewalls” of the counter-measures rule “mg_rule1”, it is decided to implement the counter-measures in respect of all of firewalls 2. Furthermore, since, as described above, the value of the “source IP” in the “counter-measures particulars” of this counter-measures rule is “detected”, by the information regarding the improper access (FIG. 8(a)), this is embodied (determined) in concrete form as “D” and as a result counter-measures particulars are determined such that all access from the IP address “D” is blocked.

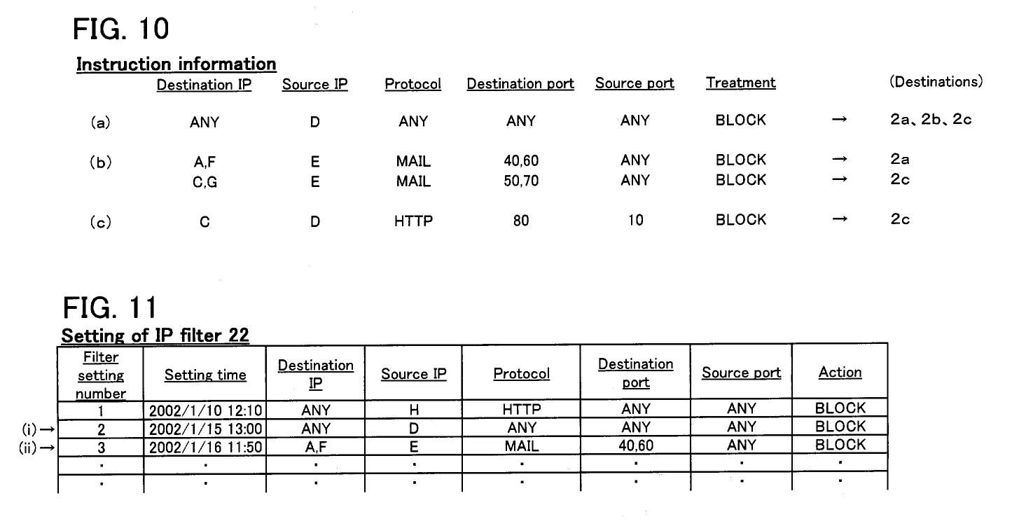

Next, the firewalls 2 where the counter-measures determined by rule administration section 14 are to be implemented and the particulars of the counter-measures in respect of each of these firewalls 2 are communicated to action section 16 through condition administration section 13. Action section 16 creates instruction information in respect of each of the firewalls 2 where counter-measures are to be implemented, from the information that is notified to it (step S8 in FIG. 6). FIG. 10 is a view showing an example of the instruction information created by action section 16. The instruction information is information for giving instructions to implement the aforesaid counter-measures particulars determined by rule administration section 14; as shown in this Figure, items such as the “destination IP” and “source IP” constituting the instruction information are the same as the items in the “counter-measures particulars” shown in the counter-measures rules of FIG. 9.

FIGS. 10(a), and (b), and (c) indicate by way of example the aforesaid instruction information created when the information of improper access indicated respectively in FIGS. 8(a), (b) and (c) is transmitted. In this case, it is assumed that manager 1 administers three firewalls 2a, 2b and 2c. In the case of FIG. 10(a), as described above, based on the “mg_rule1” of FIG. 9, same instruction information indicated in the Figure, i.e. information instructing that the counter-measure is to be implemented that all access transmitted from “D” is to be blocked, is created for all of the firewalls 2a, 2b and 2c ((destinations) of FIG. 10).

In the case of FIG. 10(b), in rule administration section 14, “mg_rule2”, of FIG. 9 is selected, causing 2a and 2c to be determined as the subject firewalls and, in addition, the “counter-measures particulars” of “mg_rule2” to be embodied in concrete form as the information shown in FIG. 8(b). As a result, instruction information is created as shown in FIG. 10(b). Specifically, in the case of firewall 2a, instruction information (upper part of FIG. 10(b)) such as to execute the counter-measure of blocking e-mail access from “E” to “A” or “F” is created and, in respect of firewall 2c, instruction information (lower part of FIG. 10(b)) such as to execute the counter-measure of blocking e-mail access from “E” to “C” or “G” is created.

Likewise also in the case of FIG. 10(c), in rule administration section 14, “mg_rule3” of FIG. 9 is selected, causing 2c to be determined as the subject firewall and furthermore the “counter-measures particulars” of “mg_rule3” are embodied in concrete form by the information shown in FIG. 8(c) and the instruction information shown in FIG. 10(c) i.e. instruction information causing the counter-measure of blocking HTTP access from “D” to “C” to be implemented is created in respect of firewall 2c.

Next, this instruction information created by action section 16 is sent to the respective corresponding firewalls 2 from communication section 11 (step S9 in FIG. 6). This instruction information that has thus been transmitted is received at the respective firewalls 2 where the counter-measures are to be implemented (step S10 in FIG. 6), causing the action agents 21 at the firewalls 2 to alter the settings of IP filters 22 in accordance with this instruction information (step S11 in FIG. 6).

FIG. 11 is a view showing an example of the setting of an IP filter 22. This Figure shows the settings in IP filter 22 of firewall 2a; for each individual setting, conditions such as the setting number, setting time and destination IP address etc and the particulars of the action are registered. The aforesaid conditions comprise the IP address of the destination and source, protocol and port numbers of the destination and source and mean that the particulars of “action” are executed when access is effected matching these conditions. For example, by setting the “filter setting number” to “1”, access by HTTP from the source whose IP address is “H” is blocked at firewall 2a.

When action agent 21 receives instruction information indicated by way of example in FIG. 10(a), the setting “2” of the “filter setting number” shown at (i) of FIG. 11 is added and when it receives the instruction information indicated by way of example in FIG. 10(b), the setting “3” of the “filter setting number” shown in (ii) of FIG. 11 is added.

When the setting of the IP filter 22 is altered (added) by action agent 21 in this way, IP filter 22 thereafter blocks access with the particulars indicated in the instruction information that has been received (step S12 in FIG. 6). Consequently, the counter-measures determined by manager 1 are implemented in each firewall 2 to which the instruction information has been sent and processing of the improper access in question detected by monitor 3 is terminated.

As described above, by employing the improper access prevention system according to this embodiment, the treatment of improper access which is detected is automatically executed in accordance with rules that are registered beforehand, so the task load on the administrator can be alleviated. Furthermore, since counter-measures adapted to the respective situation are taken in integrated fashion at a plurality of firewalls 2 in response to detection of improper access by any of monitors 3, a plurality of sites 4 can be efficiently and effectively protected. In particular, in regard to improper access that mounts a wide-ranging attack, since counter-measures are implemented at the time point where this is detected at a single location within the administrative range, protection can be executed immediately, making it possible to restrict the damage to a low level.

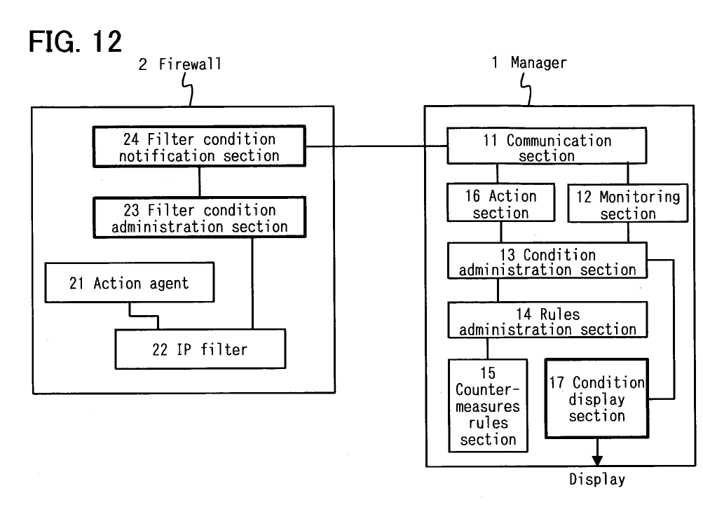

Next, a first modified example of an improper access prevention system according to this embodiment will be described. FIG. 12 is a view illustrating the construction of a manager 1 and firewall 2 according to the first modified example. As shown in this Figure, firewall 2 according to this modified example has a construction in which a filter condition administration section 23 and a filter condition notification section 24 are added. Filter condition administration section 23 is a portion that administers the setting condition of IP filter 22 and filter condition notification section 24 is a portion that receives the information of setting condition from filter condition administration section 23 and notifies this to manager 1. Both these sections may be constructed by for example a program for executing processing, a control device that executes processing in accordance with this program and a data recording device.

Also, in the construction of manager 1 according to this modified example, a condition display section 17 is added; condition display section 17 displays to the administrator etc of manager 1 the condition of each of the IP filters 22 notified to it from filter condition notification section 24 of each firewall 2. This condition display section 17 may be constructed by a program for executing processing, a control device that executes processing in accordance with this program and a display device such as a display.

An improper access prevention system according to this first modified example having the construction above aims to strengthen monitoring by making it possible for manager 1 to constantly refer to the condition of each IP firewall 22 in the administrative range.

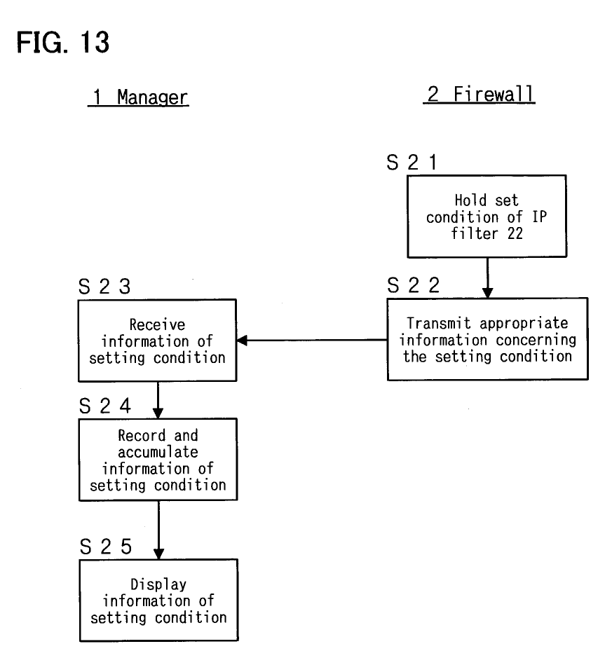

FIG. 13 is a flow chart illustrating by way of example processing relating to condition display of IP filter 22 in this modified example. In this modified example also, other processing is executed in accordance with the particulars described with reference to FIG. 6. As shown in FIG. 13, filter condition administration section 23 of each firewall 2 accesses IP filter 22 from time to time and holds the set condition of IP filter 22 as shown by way of example in FIG. 11 as information (step S21 in FIG. 13).

Next, filter condition notification section 24, with a prescribed frequency or with the timing with which the setting information of IP filter 22 that is held by this filter condition administration section 23 is updated, receives from filter condition administration section 23 the most recent information as to the setting condition, and sends this information to manager 1 (step S22 of FIG. 13).

The setting condition information of each IP filter 22 sent from filter information notification section 24 of each firewall 2 is received by the communication section 11 of manager 1 (step S23 in FIG. 13) and this information that is thus received is recorded and accumulated in condition administration section 13 (step S24 of FIG. 13). Then, in response to operation by the administrator etc, or with a prescribed timing, condition display section 17 fetches the information of setting conditions of IP filters 22 recorded in condition administration section 13 and displays this information to the administrator of manager 1 (step S25 of FIG. 13).

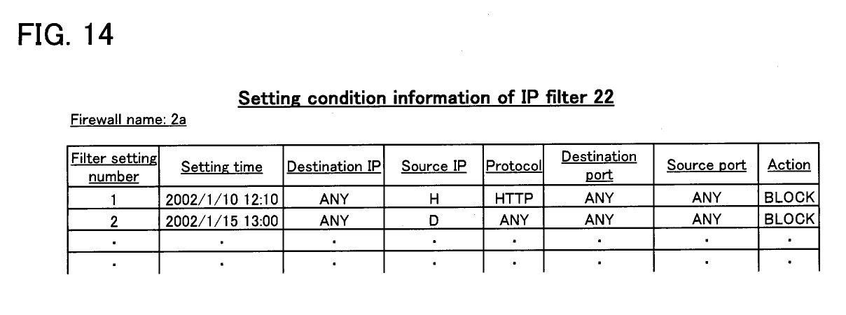

FIG. 14 is a view showing an example of the setting condition information of IP filters 22 that is displayed by condition display section 17. This Figure shows the case where the setting condition of IP filter 22 in firewall 2a is displayed; the displayed information includes the particulars of each setting described with reference to FIG. 11. By way of example, FIG. 14 shows only the information relating to a single firewall 2. However, condition display section 17 is capable of displaying the information of all of the IP filters 22 that are administered by manager 1. It is arranged that what information is to be displayed can be selected by the reader such as the administrator.

As described above, by employing the improper access prevention system according to the first modified example, the manager 1 can confirm the condition of each of the IP filters 22 in the administrative range from time to time, thereby making it possible for the administrator etc to discover at an early stage any inadequacy in the settings due for example to erroneous operation of the system. Also, by making it possible to easily grasp the setting condition of the IP filters 22, more effective improvement of the rules can be achieved by analyzing tendencies regarding improper access etc.

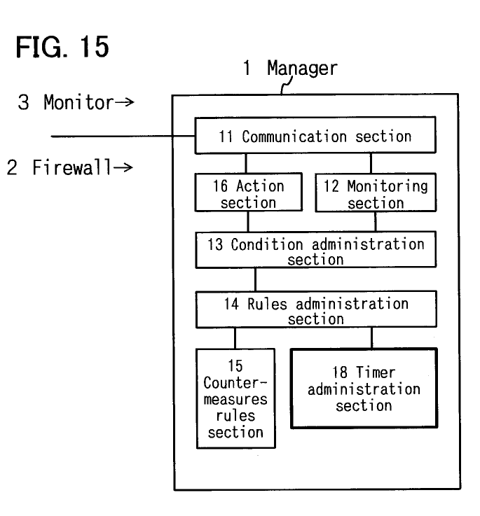

Next, a second modified example of an improper access prevention system according to this embodiment will be described. FIG. 15 is a view illustrating the construction of manager 1 according to the second modified example. As shown in this Figure, manager 1 in this modified example is constructed with the addition of a timer administration section 18. Timer administration section 18 is a portion that performs time administration in cases where counter-measures against improper access are to be implemented after lapse of a fixed time rather than being implemented immediately or when counter-measures that have been implemented are to be cancelled after lapse of a fixed time etc. This timer administration section 18 may be constructed by a program for executing processing and a control device etc for executing processing in accordance with this program.

Manager 1 according to the second modified example constructed in this way aims to minimize the occurrence of the adverse situation of communication which is in fact required becoming impossible due to implementation of counter-measures resulting from spurious detection of improper access, by re-enabling the original access by canceling counter-measures that have been taken after a prescribed time, in accordance with the particulars of the improper access detected.

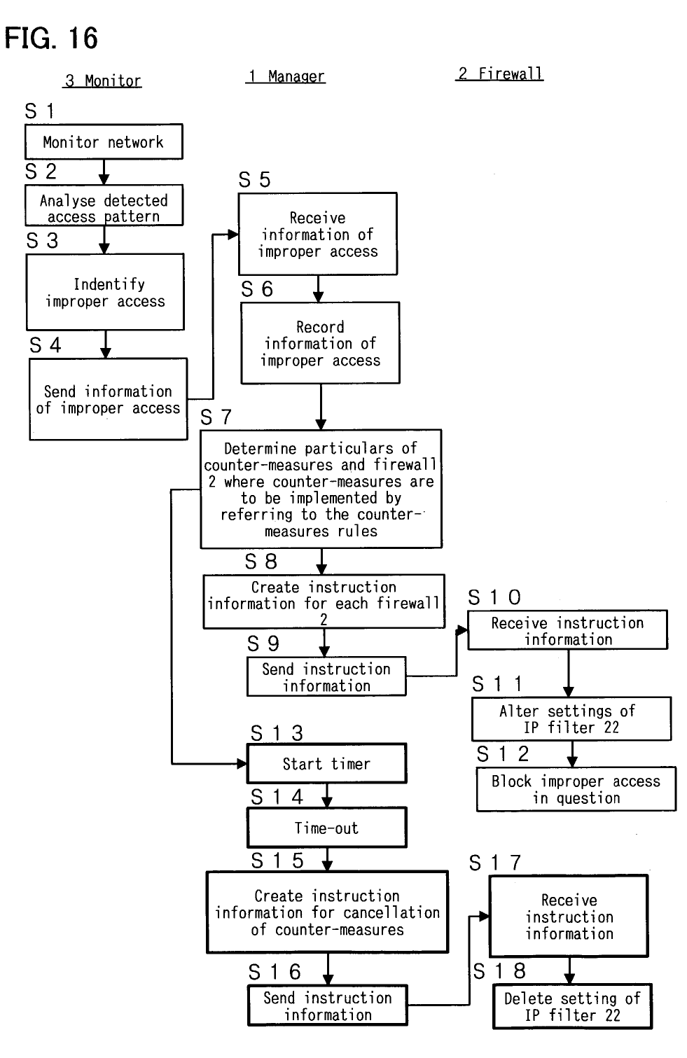

FIG. 16 is a flow chart illustrating an example of processing performed in an improper access prevention system according to the second modified example. The example illustrated in the Figure shows processing whereby, when improper access is detected, the counter-measures therefor are implemented immediately, but, if the detected improper access is of predetermined particulars, the counter-measures that have been implemented are cancelled after a prescribed time. Consequently, as will be clear from the Figure, regarding detection of improper access in monitor 3, determination of counter-measures in manager 1 and implementation of counter-measures in firewalls 2 (steps S1 to S12), processing of the same particulars as described with reference to FIG. 6 is performed. Only the aspects in which this modified example is altered will therefore be described below.

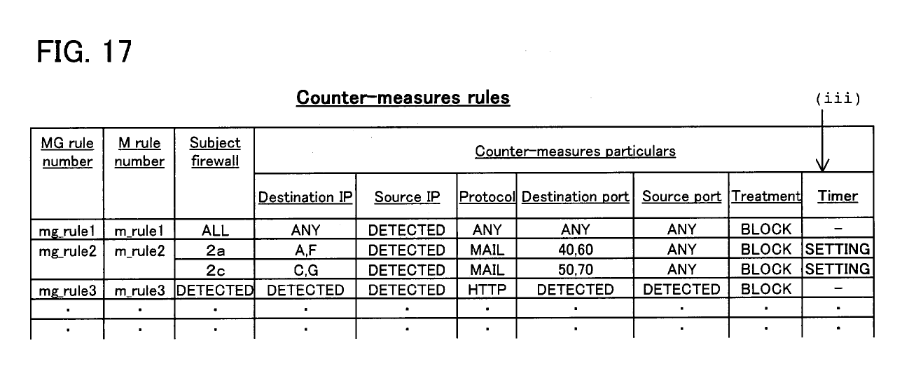

First of all, on receiving improper access information from monitor 3, rules administration section 14 of manager 1 refers to the counter-measures rules contained in counter-measures rules section 15 for determining the counter-measures and selects an appropriate counter-measures rule in accordance with the type of improper access (step S7 in FIG. 16); if the selected counter-measures rule contains particulars to the effect that timer setting should be implemented, it gives instructions to timer administration section 18 to commence time measurement. FIG. 17 is a view showing an example of a counter-measures rule in this modified example. In the counter-measures rule shown in this Figure, a column “timer” (section (iii) of FIG. 17) is added to the counter-measures rule shown in FIG. 9; if a counter-measures rule in which “setting” is prescribed in this column is selected, as described above, instructions to commence time measurement are given.

In the example illustrated in the Figure, setting of the timer is specified in “mg_rule2”. The reason for this is that the improper access which is the subject of “mg_rule2” consists in the attachment of a very large file to an e-mail and, if this counter-measure is implemented deeming as improper access in a case where a large file has mistakenly been attached with no malicious intent, communication becomes impossible. By setting up a timer, the originally required communication can be restored after a fixed time.

Returning to FIG. 16, timer administration section 18 which has received the aforesaid instruction starts time measurement (step S13 in FIG. 16) and, at the time point where a predetermined time has elapsed (time-out time point), notifies rule administration section 14 of this fact (step S14 in FIG. 16). On receipt of this notification, rule administration section 14 instructs action section 16 to issue instructions to cancel the counter-measure that has implemented in accordance with the selected counter-measures rule.

On receiving this, action section 16 creates information giving instructions for cancellation of the aforesaid counter-measure (step S15 in FIG. 16) and this instruction information is sent from communication section 11 to each firewall 2 where the counter-measure was implemented (step S16 in FIG. 16). At each firewall 2 that has received this instruction information (step S17 in FIG. 16), the action agent 21, in accordance with this instruction, cancels the particulars set by the aforesaid counter-measure in IP filter 22 (step S18 in FIG. 16). Thereafter, the condition prior to implementation of this counter-measure is restored and communication in accordance with the access particulars that was denied by the aforesaid counter-measure becomes possible.

By employing the improper access prevention system according to the second modified example described above, even in cases where counter-measures are implemented due to mistaken detection of improper access where in fact counter-measures ought not to be implemented, the originally required communication can be ensured by removing such counter-measures after a prescribed time, thereby making it possible to minimize the adverse effects resulting from such automatic implementation of counter-measures.

Although the above example was a case in which only information as to whether or not to implement timer setting was introduced into the counter-measures rules, it would be possible to specify in the counter-measures rules the time up to cancellation of the counter-measure, in other words the period for which the counter-measure is to be implemented, this time being altered for each counter-measures rule. Also, although, in this example, whether or not to set a timer or the setting time thereof was specified in accordance with the type of improper access detected, it would be possible to specify this in accordance with some other item such as the transmission destination or transmission source of the improper access. For example, it would be possible to adopt the strategy of re-enabling communication after a fixed time with correspondents with whom communication for business reasons is frequent when improper access is detected from such correspondents, irrespective of the particulars of this improper access.

Also, although, in the above example, the timing for cancellation of counter-measures was determined in accordance with time, it would be possible to specify some other index such as number of accesses after implementation of the counter-measure. Furthermore, although timer administration section 18 in the above example performed administration of the time until cancellation of the implemented counter-measures, it could be made to perform time administration in the case where counter-measures are executed after lapse of a fixed time after detection of improper access. In such cases, rules administration section 14 gives instructions for implementation of counter-measures after receiving notification of time-lapse from timer administration section 18.

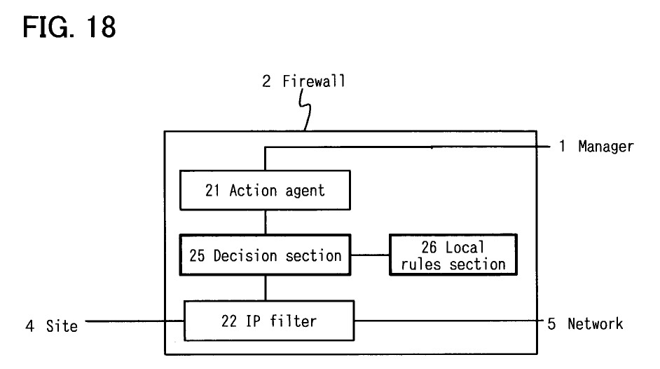

Next, a third modified example of the improper access prevention system according to this embodiment will be described. FIG. 18 is a view illustrating the construction of a firewall 2 according to the third modified example. As shown in this Figure, the firewall 2 in this modified example is constructed with the addition of a decision section 25 and a local rules section 26. Decision section 25 is a portion that decides whether or not to perform alteration of the setting of IP filter 22 in accordance with the instruction information transmitted from manager 1; local rules section 26 is a portion that stores local rules for this decision. Decision section 25 and local rules section 26 could be constituted by a program for executing processing, a control section for executing the processing in accordance with this program and a data recording device etc.

With an improper access prevention system according to the third modified example having the construction as above, more flexible response can be achieved by determining whether or not to implement the counter-measures in accordance with instructions from manager 1 in accordance with respectively independent local rules at each firewall 2.

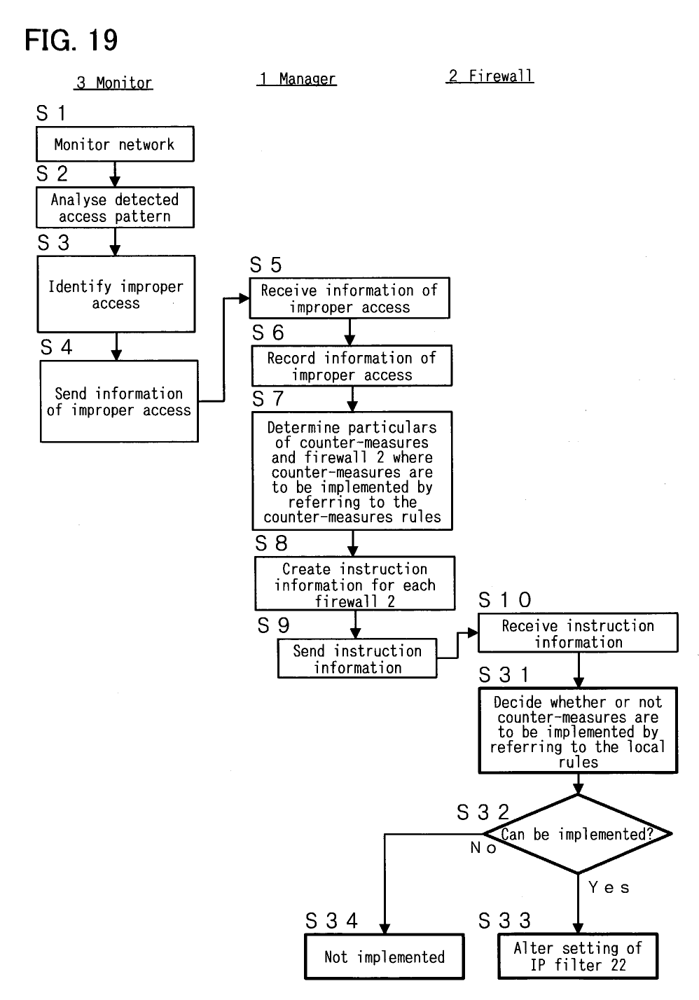

FIG. 19 is a flow chart showing an example of the processing performed in an improper access prevention system according to the third modified example. The processing in monitor 3 and manager 1 in this improper access prevention system according to this modified example (step S1 to S9 in FIG. 19) is the same as the particulars described with reference to FIG. 6, so further description thereof is omitted. Hereinbelow, the content of processing at firewall 2, which constitutes the point of difference of this modified example, is described.

Action agent 21 at each firewall 2 that has received instruction information transmitted from manager 1 (step S10 in FIG. 19) transmits to decision section 25 the particulars of the alteration of setting of IP filter 22 in accordance with this instruction information. When this happens, decision section 25 decides whether it is possible to implement the setting alteration notified thereto by referring to the local rules of local rules section 26 (step S31 of FIG. 19). If it decides that implementation is possible (Yes of step S32 of FIG. 19), it alters the setting of IP filter 22 in accordance with the particulars of setting alteration notified thereto (step S33 in FIG. 19). In this case, counter-measures are implemented in accordance with the instructions of manager 1. On the other hand, if it decides that implementation is not possible (No in step S32 of FIG. 19), it does not implement this alteration of settings transmitted thereto (step S34 of FIG. 19). Counter-measures in accordance with the instruction from manager 1 are therefore not implemented.

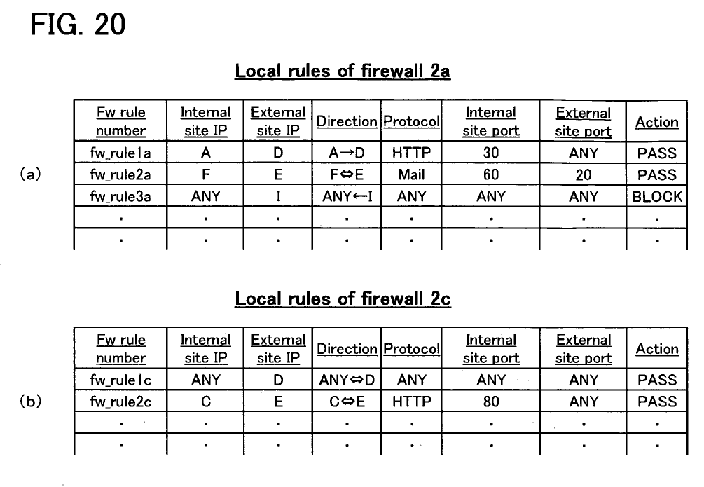

FIG. 20 is a view showing examples of local rules stored in local rules section 26 of firewall 2. (a) and (b) of this Figure indicate the local rules that are laid down in local rules 2a and 2c respectively described above; these local rules are registered/altered as needed for each firewall 2. As shown in this Figure, these local rules each comprise an item indicating communication particulars from the “internal site IP” to “external site port” and an “action” item. “internal site IP” and “external site IP” are the IP addresses of the source and destination of the communication and “direction” indicates the direction of the communication. Also “internal site port” and “external site port” are the port numbers of the source and destination of the communication and “protocol” is of course the protocol of the communication.

Also “action” specifies the action to be taken at IP filter 22 in respect of communication matching the items indicated by the above communication particulars. For example, local rule “fw_rule1a” in (a) of this Figure specifies that communication by HTTP from “A” within the site 4a controlled by firewall 2a to external “D” is not to be blocked but always to be allowed. “ANY” in the Figure indicates that the value is not specified, “PASS” and “BLOCK” respectively indicate allowance and denial of communication.

The decision in decision section 25 in accordance with these local rules is taken as follows in the case where the instruction information shown for example in FIG. 10(a), namely, an instruction to the effect that all types of communication from “D” are to be denied, is transmitted. First of all in firewall 2a the local rule indicated by (a) of FIG. 20 is employed and “fw_rule1a”, which is the rule relating to communication with “D” is referred to. In this rule “fw_rule1a”, in the column “direction” “A→D” is indicated and in the column “action” “PASS” is indicated, so this means that communication from “A” to “D” is always to be guaranteed, but, since the direction of the communication that is to be guaranteed is opposite to the communication of the instruction, this local rule does not contradict the content of the instruction. In this case it is therefore concluded that counter-measures can be taken in accordance with the instruction.

Also, at firewall 2c, the local rule of FIG. 20(b) is referred to. In this case, in “fw_rule1c”, it is specified that communication with “D” in any direction is to be allowed, as shown by the entry in the “direction” column etc. Decision section 25 therefore decides that the contents of this instruction i.e. to refuse all communications from “D” cannot be accepted, and counter-measures in accordance with this instruction information are not implemented.

Also, as another example, when the instruction information indicated in FIG. 10(b) is transmitted, instruction information is received in firewall 2a as shown in the upper part of FIG. 10(b) to the effect that access by e-mail from “E” to “A” or “F” is to be blocked. At firewall 2a, the “fw_rule2a” of FIG. 20(a) is referred to and a decision “PASS” is made to pass communication by e-mail between “F” and “E”. Of the aforesaid instructions, counter-measures are therefore implemented only in respect of e-mails from “E” to “A” that do not conflict with the aforesaid local rules. In this way, it can be arranged to implement only some of the instructions from manager 1.

In contrast, firewall 2c refers to the local rule shown in FIG. 20(b) when instruction information to block access by e-mail from “E” to “C” or “G” as shown in the lower part of FIG. 10(b) is received. Specifically, “fw_rule2c” that is specified in respect of communication of “C” and “E” is referred to, but the requirements in accordance with this local rule relate to communication whose protocol is “HTTP” so this local rule does not contradict the aforesaid instruction. Consequently, counter-measures are implemented in accordance with the aforesaid instruction.

As described above, in the case of the third modified example, whether or not to follow the instructions of manager 1 is decided for each firewall in accordance with independent local rules laid down for each firewall 2, so it can be arranged for counter-measures specified by the aforesaid instructions not to be implemented in cases where these are inappropriate. If therefore at a given site 4 circumstances occur such that it is desired to temporarily preserve specified communication for a short period, this can easily be achieved by altering the local rules in firewall 2 of this site 4 without needing to alter the counter-measures rules in manager 1. Also, the situation can easily be coped with that circumstances have arisen at a particular site 4 that require specified communication to be urgently denied or to be ensured.

Thus, by adopting the improper access prevention system according to this modified example, it is possible to cope with temporary circumstances at the local level and protection of a plurality of sites 4 can be achieved in a more flexible and effective manner.

As described above, with the present invention, the administration means makes the protection means such as firewalls automatically implement counter-measures so the task load on the administrator can be alleviated. In addition, counter-measures appropriate to the respective situations at a plurality of protection means are taken in integrated fashion in response to improper access detected by any of the detection means so a plurality of sites can be effectively and efficiently protected.

The range of protection of the present invention is not restricted to the embodiment described above but extends to the invention as set out in the patent claims and equivalents thereof.

What is claimed is:

1. An improper access prevention program for causing a computer connected, through a network, with a plurality of protection means that respectively execute counter-measures for protecting a plurality of prescribed sites from improper access through said network and with a plurality of detection means that respectively detect said improper access, to execute processing for preventing said improper access, said preventing processing comprising:
a first step of receiving information relating to improper access detected by any of said detection means from the detection means that detected the improper access;
a second step of, in accordance with said received information relating to improper access, deciding on said protection means where counter-measures in respect of the improper access are to be implemented and deciding said counter-measures in respect of each said decided protection means; and
a third step of sending instruction information for implementation of each said decided counter-measures to each said decided protection means.

2. The improper access prevention program according to claim 1, wherein said information relating to the improper access includes the type of said improper access, and said decision regarding the protection means where said counter-measures are to be implemented in said second step is performed in accordance with said type of the improper access.

3. The improper access prevention program according to claim 1, further comprising:
a step of storing predetermined rules in a counter-measures rules section, wherein
the decision regarding said counter-measures and said protection means where said counter-measures are to be implemented in the second step is performed in accordance with said stored rules.

4. The improper access prevention program according to claims 1, further comprising:
a fourth step of sending instruction information, in regard to each said protection means that received said instruction information in said third step, to stop said counter-measures in respect of which instructions for execution were given by said instruction information.

5. The improper access prevention program according to claim 4, wherein said fourth step is executed with a predetermined timing after said second step.

6. The improper access prevention program according to claim 4, wherein said fourth step is executed if the type of said improper access that is detected is a predetermined type that is the subject of stoppage of counter-measures.

7. The improper access prevention program according to claim 4, wherein said fourth step is executed if said detected transmission source of said improper access is a predetermined communication correspondent with whom communication is deemed necessary.

8. The improper access prevention program according to claims 1, further comprising:
a step of receiving information relating to the condition of implementation of said counter-measures at said protection means from said protection means and displaying the received information relating to the condition of implementation.

9. An improper access prevention program for causing a protection computer that protects a prescribed site from improper access through a network, to execute processing for implementing counter-measures in respect of said improper access in accordance with instructions from an administration computer that administers said protection computer, said implementing processing comprising:
a receiving step of receiving from said administration computer instruction information designating the counter-measures to be implemented in respect of said improper access decided on by said administration computer, through said network;
a decision step of deciding whether or not counter-measures in respect of the improper access decided by said administration computer in accordance with said instruction information are to be implemented, in accordance with rules stored beforehand in a local rules section, in association with said protection computer; and
an implementation step wherein, if, in said decision step, it is decided that counter-measures in respect of said improper access are to be implemented, the counter-measures are implemented and wherein if it is decided that counter-measures in respect of said improper access are not to be implemented the counter-measures are not implemented.

10. The improper access prevention program according to claim 9, wherein the decision in said decision step that said counter-measures is to be implemented against said improper access includes the decision that some of the counter-measures decided by said administration computer should be implemented; and
if it is decided that some of said counter-measures should be implemented in said decision step, some of said counter-measures are implemented in said implementation step.

11. A method of preventing improper access in administration means connected, through a network, with a plurality of protection means that execute counter-measures for protecting prescribed sites from improper access through the network, and with a plurality of detection means that detect said improper access, comprising:
a first step of receiving information relating to improper access detected by any of said detection means from the detection means that detected the improper access;
a second step of, in accordance with said received information relating to improper access, deciding on said protection means where counter-measures in respect of the improper access are to be implemented, and deciding said counter-measures in respect of each said decided protection means; and
a third step of sending instruction information for implementation of each said decided counter-measures to each said decided protection means.

12. A method of preventing improper access in protection means that protects a prescribed site from improper access through a network comprising:
a receiving step of receiving from administration means that administers said protection means instruction information designating the counter-measures to be implemented in respect of said improper access decided on by said administration means, through said network;
a decision step of deciding whether or not counter-measures in respect of the improper access decided by said administration means in accordance with said instruction information are to be implemented, in accordance with rules stored beforehand in said protection means; and
an implementation step wherein, if it is decided in said decision step that counter-measures in respect of said improper access are to be implemented, the counter-measures are implemented and wherein if it is decided that counter-measures in respect of said improper access are not to be implemented these counter-measures are not implemented.

13. A recording medium on which is recorded an improper access prevention program for causing a computer connected, through a network, with a plurality of protection means that execute counter-measures for protecting prescribed sites from improper access through said network and with a plurality of detection means that detect said improper access, to execute processing for preventing said improper access, said preventing processing comprising:
a first step of receiving information relating to improper access detected by any of said detection means from the detection means that detected the improper access;
a second step of, in accordance with said received information relating to improper access, deciding on said protection means where counter-measures in respect of the improper access are to be implemented and deciding said counter-measures in respect of each said decided protection means; and
a third step of sending instruction information for implementation of each said decided counter-measures to each said decided protection means.

14. A recording medium on which is recorded an improper access prevention program for causing a protection computer that protects a prescribed site from improper access through a network, to execute processing for implementing counter-measures in respect of said improper access in accordance with instructions from administration means that administers the protection computer, said implementing processing comprising:
a receiving step of receiving from said administration means instruction information designating the counter-measures to be implemented in respect of said improper access decided on by said administration means, through said network;
a decision step of deciding whether or not counter-measures in respect of the improper access decided by said administration means in accordance with said instruction information are to be implemented, in accordance with rules stored beforehand in said protection computer; and
an implementation step in which, if it is decided in said decision step that counter-measures in respect of said improper access are to be implemented, the counter-measures are implemented and if it is decided that counter-measures in respect of said improper access are not to be implemented the counter-measures are not implemented.

15. An improper access prevention device connected, through a network, with a plurality of protection means that execute counter-measures for protecting prescribed sites from improper access through said network and with a plurality of detection means that detect said improper access, which:
receives information relating to improper access detected by any of said detection means from the detection means that detected the improper access;
in accordance with said received information relating to improper access, decides on said protection means where counter-measures in respect of the improper access are to be implemented and decides said counter-measures in respect of each said decided protection means; and
sends instruction information for implementation of each said decided counter-measures to each said decided protection means.

16. A protection device that protects a prescribed site from improper access through a network, which:
receives from administration means that administers said protection device instruction information designating the counter-measures to be implemented in respect of said improper access decided on by said administration means, through said network;
decides whether or not counter-measures in respect of the improper access decided by said administration means in accordance with said instruction information are to be implemented, in accordance with rules stored beforehand; and
if it is decided that counter-measures in respect of said improper access are to be implemented, implements the counter-measures and if it is decided that counter-measures in respect of said improper access are not to be implemented does not implement the counter-measures.

17. An improper access prevention system for preventing improper access through a network, comprising:
a plurality of protection means that protect prescribed sites from said improper access by implementing counter-measures in respect of said improper access;
a plurality of detection means that detect said improper access; and
administration means connected with said plurality of protection means and said plurality of detection means through said network, that receives information relating to improper access detected by any of said detection means from the detection means that detected the improper access and, decides on said protection means where counter-measures in respect of the improper access are to be implemented, decides on said counter-measures in respect of each said decided protection means in accordance with said received information relating to the improper access and sends instruction information for implementing each said decided counter-measures to each said decided protection means.

18. The method of preventing improper access according to claim 11, further comprising:
a fourth step of sending instruction information, in regard to each said protection means that received said instruction information in said third step, to stop said counter-measures in respect of which instructions for execution were given by said instruction information.

19. The method of preventing improper access according to claim 12, wherein the decision in said decision step that said counter-measures is to be implemented against said improper access includes the decision that some of the counter-measures decided by said administration means should be implemented; and
if it is decided that some of said counter-measures should be implemented in said decision step, some of said counter-measures are implemented in said implementation step.
